(19) United States
(12) Patent Application Publication
(10) Pub. No.: US 2026/0129003 A1
(43) Pub. Date: May 7, 2026

(54) SEPARATION OF COMPUTE AND STORAGE RESOURCES IN COMMUNICATIONS NETWORK

(71) Applicant: InterDigital Patent Holdings, Inc., Wilmington, DE (US)

(72) Inventors: Michael Starsinic, Newtown, PA (US); Ulises Olvera-Hernandez, Saint-Lazare (CA); Michel Roy, Candiac (CA); Samir Ferdi, Kirkland (CA); Rocco Di Girolamo, Laval (CA); Saad Ahmad, Montreal (CA)

(73) Assignee: InterDigital Patent Holdings, Inc., Wilmington, DE (US)

(21) Appl. No.: 18/940,417

(22) Filed: Nov. 7, 2024

(51) Int. Cl. H04L 47/80

(52) U.S. Cl. CPC H04L 47/805

(57) ABSTRACT

Example procedures for managing wireless transmit/receive unit (WTRU) context are disclosed herein. A base station may receive, from a WTRU, a first message including a first payload, a second payload, and an indication of a service type. The base station may select, based on the first payload, compute resources to execute the indicated service type. The base station may send, to a network entity comprising the selected compute resources, a request message requesting the selected compute resources to execute the indicated service type, wherein the request message includes the second payload. The base station may receive, from the network entity, a first response message including an indication that a service of the indicated service type was invoked successfully, quality of service (QoS) configuration information for the base station, a context identifier, and payload response information for the WTRU. The base station may send the payload response information to the WTRU.

### BACKGROUND

According to the 3rd Generation Partnership Project (3GPP), a network function (NF) may be a function in a network that has defined functional behavior and 3GPP defined interfaces. A network function may be implemented, for example, as a network element on dedicated hardware, as a software instance running on dedicated hardware, or as a virtualized function instantiated on an appropriate platform (e.g., on a cloud infrastructure). A network function set (NF set) may be a group of interchangeable NF instances of the same type supporting the same services and the same network slice(s). The NF instances in the same NF set may be geographically distributed and may have access to the same context data.

NFs may be associated with storage resources. The storage resources may be used to store context information. The context information may be wireless transmit/receive unit (WTRU) specific. The storage resources may be dedicated to an NF instance or dedicated to an NF Set. The storage resources may be deployed as an Unstructured Data Storage Function (UDSF). 3GPP Fifth Generation (5G) systems may include context storage. For example, a 5G Core Network (CN) may include NFs. The functionality that is provided by an NF is accessed by invoking a service operation of the NF. Each NF may have storage (i.e., memory) resources and the storage resources may be used for storing context information (e.g., WTRU context).

An Access and Mobility Function (AMF) is an example of an NF. During a WTRU Registration procedure, an AMF may create and store WTRU context (UE context). The WTRU context may include identifiers of the WTRU (e.g., Subscription Permanent Identifier (SUPI) or 5G Globally Unique Temporary Identifier (5G-GUTI)), information about NFs that serve the WTRU (e.g., the identity of a Policy Control Function (PCF) that serves the WTRU for Access and Mobility (AM) policies), WTRU subscription information that was obtained from the User Data Management (UDM)/ User Data Repository (UDR), network slices that the WTRU is allowed to access (i.e., an Allowed Network Slice Selection Assistance Information (NSSAI)), and information about Protocol Data Unit (PDU) Sessions of the WTRU (e.g., the identity of the Session Management Function (SMF) that serves each PDU Session). The AMF may access the WTRU context when the AMF needs to invoke services of other NF(s). For example, the AMF may receive an N1 message container (i.e., received over the N1 interface) from a Radio Access Network (RAN) Node. The N1 message container may include a Non-Access Stratum Session Management (NAS-SM) Message (e.g., a PDU Session Modification Request Message) and a PDU Session identity (ID). The AMF may use information in the WTRU Context to determine which SMF serves the PDU Session that is associated with the PDU Session ID. The AMF may then send the NAS-SM message to the SMF that serves the PDU Session. The AMF may send the NAS-SM message to the SMF by invoking a service (e.g., the Nsmf_PDUSession_UpdateSMContext service) of the SMF.

An SMF is an example of an NF. During a PDU Session Establishment procedure, an SMF may create and store SM Context. SM context may also be called PDU Session context. The SM context may include a PDU Session ID, Data Network Name (DNN), Policy and Charing Control (PCC) Rules, Quality of Service (QoS) Profiles, N4 Rules, QoS Rules, Single NSSAI (S-NSSAI), and the identity of the PCF that serves the PDU Session. The AMF may access the SM context when the AMF needs to modify the QoS Rules, QoS Profiles, or N4 Rules of the PDU Session. For example, a SMF may receive a Npcf_SMPolicyControl_UpdateNotify notification from the PCF that services the PDU Session and the notification can provide new PCC Rules to the SMF. The new PCC Rules may trigger the SMF to change the QoS Rules, QoS Profiles, or N4 Rules of the PDU Session.

NFs may be deployed in network function sets. A network function set is a group of interchangeable NF instances of the same type that support the same services and the same Network Slice(s). The NF instances in the same NF Set may be geographically distributed and may have access to the same context data. In other words, the NF instances of the same NF Set have access to the same storage resources. For example, each NF in the NF set may have compute resources that are dedicated to the NF and may be able to access some storage resources that are common to the NF. Thus, any service of the NF Set may be invoked by an invoker (e.g., a RAN node/base station) as long as the NF Set has access to the context data that is used to provide the invoked service operation. The storage resources of a network function set may be an unstructured data storage function (UDSF).

Selection of compute and storage resources (i.e., NF selection) in 5G system includes selection of NFs to serve a WTRU (UE). Examples of selection of compute and storage resources in 5G systems include: a RAN Node or AMF may select an AMF to serve the WTRU; an AMF may select an SMF to serve a WTRU's PDU Session; an AMF may select a PCF to serve a WTRU for Access and Mobility (AM) policies; and an SMF may select a PCF to serve a WTRU's PDU Session. Selection of the NF influences where WTRU context is stored. For example, once an SMF is selected to serve a PDU Session, the SM Context that is associated with the PDU Session must be stored in the SMF or in storage function that is accessible to the SMF.

### SUMMARY

Example procedures for managing wireless transmit/receive unit (WTRU) context are disclosed herein. A base station may receive, from a WTRU, a first message including a first payload, a second payload, and an indication of a service type. The base station may select, based on information in the first payload, compute resources to execute the indicated service type. The base station may send, to a network entity comprising the selected compute resources, a request message requesting the selected compute resources to execute the indicated service type, wherein the request message includes the second payload. The base station may receive, from the network entity comprising the selected compute resources, a first response message including an indication that a service of the indicated service type was invoked successfully, quality of service (QoS) configuration information for the base station, a context identifier, and payload response information for the WTRU. The base station may send, to the WTRU, a second response message including the payload response information for the WTRU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example storage function architecture;

FIG. 3 is a signaling diagram illustrating an example session creation procedure for WTRU context creation in a network;

FIG. 4 is a flow diagram illustrating an example session creation procedure for WTRU context creation in a network, which may be performed by a base station;

FIG. 5 is a flow diagram illustrating an example session creation procedure for WTRU context creation in a network, which may be performed by a WTRU;

FIG. 6 is a signaling diagram illustrating an example PCF-initiated change procedure in a network;

FIG. 7 is a signaling diagram illustrating an example procedure for PCF-initiated change based on a RAN Notification in a network;

FIG. 8 is a signaling diagram illustrating an example procedure for PCF-initiated change based on an AF notification in a network; and

FIG. 9 is a signaling diagram illustrating an example procedure for WTRU-initiated change in a network.

### DETAILED DESCRIPTION

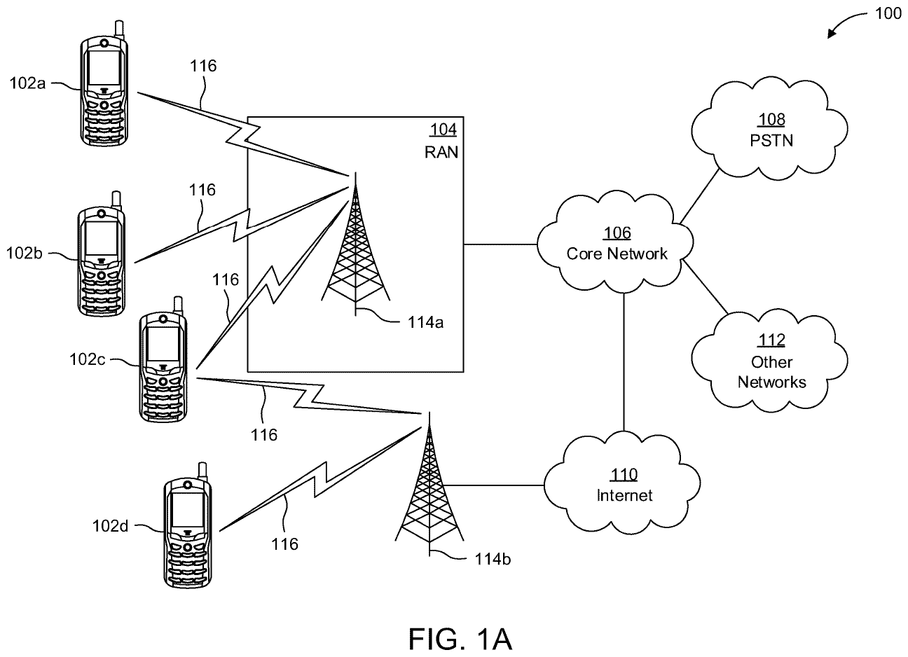

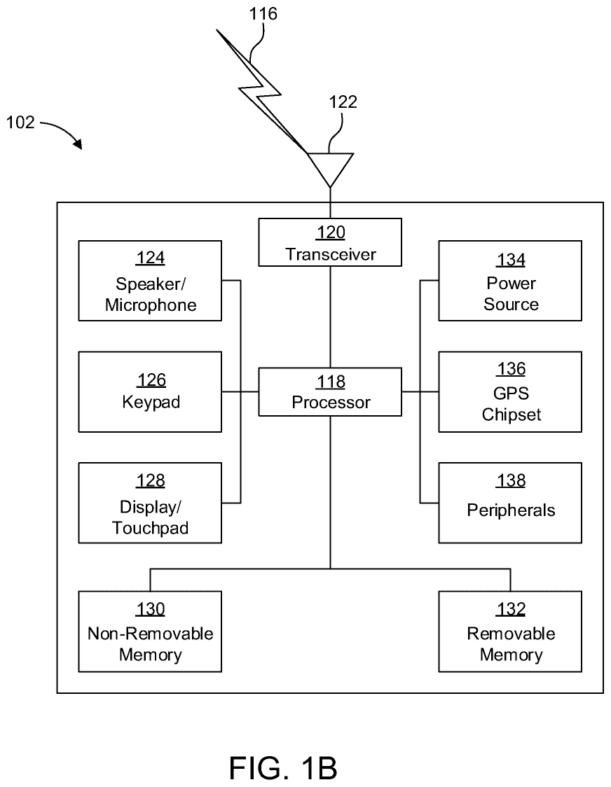

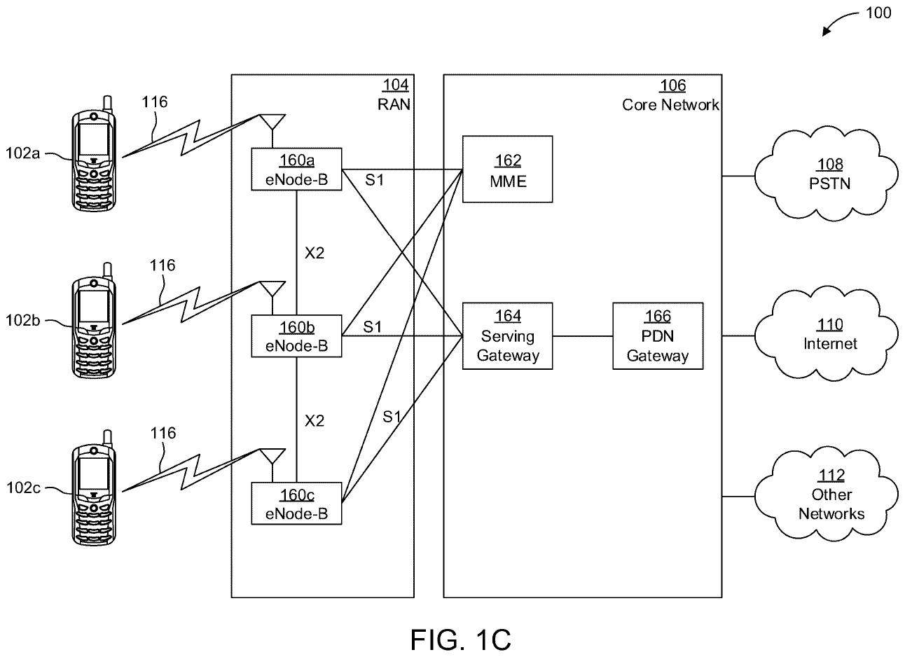

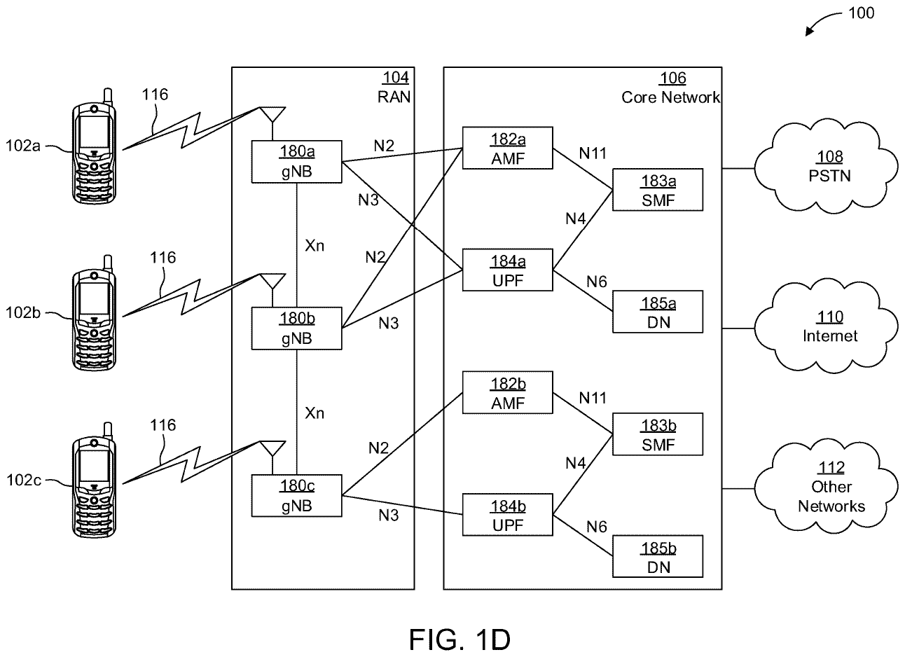

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95(IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The embodiments described herein relate to a network architecture that may not rely on network functions to provide services. Rather, a proposed network architecture, as described with respect to the procedures and embodiments described herein, may be based on the invocation of services that may be executed by any suitable set of compute resources. According to the proposed architecture, a set of static compute resources does not need to be selected to service a WTRU. When a service needs to be invoked, compute resources may be selected without regard to the compute resources that last executed a service invocation related to the same set of WTRU context information. According to the proposed architecture, only storage resources may need to be selected for storing the WTRU context.

The following terms may be used herein. Context information and context data may be used interchangeably herein. N4 may refer to an interface between an SMF and a UPF. N4 Rules may refer to rules that are sent from an SMF to a User Plane Function (UPF). N4 Rules may be used by the UPF to determine how to process uplink and downlink data. Compute Resources may refer to computation resources that run an instance of a stateless service. The Compute Resources may reside, for example, in the core network (e.g., an entity in the core network such as a server). Selection of Compute Resources may refer to selection of a Service Instance. A context identifier may also be called a data key. PCC Rules may describe traffic and may indicate what QoS Treatment is required for the described traffic. PCC Rules may be associated with a PDU Session and may be generated by a policy engine such as the PCF.

The SMF may use PCC Rules to generate QoS Rules. QoS Rules may describe uplink traffic and may indicate what QoS Treatment is required for the described traffic. QoS Rules may be associated with a PDU Session. The SMF may send QoS Rules to the WTRU. The SMF may use PCC Rules to generate N4 Rules. N4 Rules may describe uplink and/or downlink traffic and may indicate what QoS Treatment is required for the described traffic. N4 Rules may be associated with a PDU Session. The SMF may send N4 Rules to the UPF. The SMF may use PCC Rules to generate QoS Profiles. QoS Profiles may describe uplink and/or downlink traffic and may indicate what QoS Treatment is required for the described traffic. QoS Profiles may be associated with a PDU Session. The SMF may send QoS Profiles to the RAN. The terms Base Station, RAN Node, gNodeB, and eNodeB may be used interchangeably herein.

An example embodiment includes RAN invocation of a session management service. According to an example procedure of RAN invocation of a session management service, a RAN Node (base station) may perform any one or more of the following steps. The RAN Node may receive a message from a WTRU that includes at least a Service Invoker Payload (a first payload), a Service Payload (a second payload), and an indication of a service type. The RAN Node may use information from the Service Invoker Payload to select compute resources to execute the indicated type of service. The information in the Service Invoker Payload may include a Data Network Name (DNN). The RAN Node may send a request to the selected compute resources to execute the indicated service type and include the Service Payload in the request. The RAN Node may receive a response from the compute resources. The response may include an indication that the service invocation was successful, a QoS Configuration (i.e., QoS Profile) for the RAN Node, a context identifier, and/or a payload response for the WTRU. The RAN Node may send the payload response to the WTRU. The payload response may include QoS Configuration for the WTRU (i.e., QoS Rules) for the PDU Session. The payload response may include the context identifier and PDU Session ID.

An example embodiment includes a PCF adjusting PCC rules based on a RAN notification. According to an example procedure of a PCF adjusting PCC rules based on a RAN notification, a PCF may perform any one or more of the following steps. The PCF may receive a context creation notification. The notification may include a PDU Session ID and a context identifier. The notification may serve as an indication that the PCF is serving the PDU Session. The notification may be received from an SM Service or a Storage Function. The PCF may receive a notification from a RAN Node that the QoS Configuration of the PDU Session cannot be satisfied by the network. The notification may include a PDU Session ID. The PCF may use the PDU Session ID to determine a context identifier. The PCF may use the context identifier to read context for the PDU Session from a storage function. The PCF may use information from the notification and the context to generate PCC Rules. The PCF may store the PCC Rules in the context. The PCF may invoke an SM Service so that QoS for the PDU Session will be re-configured based on the new PCC Rules (i.e., based on the RAN Notification).

The Service Based Architecture of the 5G System involves a tight coupling between compute resources and storage resources. Selection of a NF has a direct impact on what compute and storage resources will be used to provide the desired services (e.g., service of PDU Session, management of AM policies, management of PDU Session Policies, and mobility management services). Tight coupling between compute and storage resources results in less flexibility in how networks are deployed and a more complicated service design. For example, it may be that some services are heavily dependent on WTRU location. Thus, NFs sometimes need to be designed to consider WTRU location when providing a service or when triggering NF reselection when the WTRU's location changes. If the NF is able to consider WTRU location, then there is an implication that the NF is configured to behave differently depending on the WTRU's location, which may result in more complicated design and configuration. If an NF triggers NF reselection each time the WTRU's location changes, then the result will be increased network signaling and processing delays.

Architecture enhancements, or new architectures, are desired that better decouple compute resources and storage resources. A benefit of decoupling compute resources and storage resources will result in reduced dependency between selection of storage resources and selection of compute resources. Thus, reselection of compute resources may not be necessary each time a WTRU changes location, and/or only context needs to be relocated when a WTRU changes location. Another desired benefit of compute resource and storage resources decoupling is that it can provide the operator with more flexibility in how resources are allocated in the network, as some tasks or workload are storage Input/Output bound (e.g., storage of larger amount of data such as for Artificial Intelligence Machine Learning (AIML)/analytics purposes) while other are processor bound (e.g., model training, analytics processing). In current system such functionality may be integrated into a single function (e.g., Network Data Analytics Functions (NWDAF)).

Another desired benefit of compute resources and storage resources decoupling is that it can provide network scalability and network management benefits to network operators. By decoupling storage from compute resources, it becomes easier to scale the compute resources (e.g., increase or decrease) based on the dynamic network usage. Similarly, it becomes easier for the network operator to deploy a new NF without impacting network users. This can be useful, for example, if maintenance is required on infrastructure nodes, or if new versions of a network function need to be progressively deployed. The network architecture described herein does not rely on network functions to provide services. In other words, the network architecture disclosed herein does not rely on network functions that have tightly integrated compute resources and storage resources. Rather, the network architecture assumes that network function functionality is disaggregated and the compute resources and storage resources are not tightly coupled.

The network architecture disclosed herein is based on the invocation of services that can be executed by any suitable set of compute resources. Thus, in the proposed architecture, a set of static compute resources does not need to be selected to service a WTRU. When a service needs to be invoked, compute resources may be selected without regard to the compute resources that last executed a service invocation related to the same set of WTRU context information. In the proposed architecture, only storage resources (and not compute resources) need to be selected for storing the WTRU context. The foreseen benefits for the operator may be include for example Capital expenditures (CAPEX) and operating expenses (OPEX) reduction by means of deployment of off the shelf compute resources and/or storage resources. Example procedures are described in the following in the context of the proposed network architecture with decoupled compute resources and storage resources.

Example procedures for managing WTRU context are described in the following. The examples procedures focus on session management context, however the examples procedures may be used to manage any other type of WTRU context. In the following examples, it may be assumed that the WTRU is a subscriber of a Home Public Land Mobile Network (HPLMN). In the following examples, RAN Node 1 and RAN Node 2 may be RAN Nodes of a Visited Public Land Mobile Network (VPLMN). The User Plane Function (UPF) may be a Network Function. The UPF is a data plane anchor that is used to route Internet Protocol (IP) Packets between a WTRU and a data network. Therefore, the UPF may be associated with fixed (or predetermined) hardware (i.e., compute and storage resources). In the examples, the User Data Repository (UDR) is a Network Function. The UDR is a database that stores WTRU Subscription data and policy information. Th UDR is used by services and network functions to obtain and update WTRU Subscription data and policy information. Therefore, the UDR may be associated with fixed (or predetermined) hardware (i.e., compute and storage resources). In the examples, the Policy Control Function (PCF) is a Network Function. The PCF is a network function that creates and updates policies for PDU Sessions. The PCF needs to be addressable by an Application Function (AF) so that an AF can request to create or modify policies for flows within a PDU Session. Therefore, the PCF is associated with fixed (or predetermined) hardware (i.e., compute and storage resources). In the examples, the Service Management (SM) Service is not a Network Function. Rather, the SM Service is a stateless service.

### Storage Function Architecture

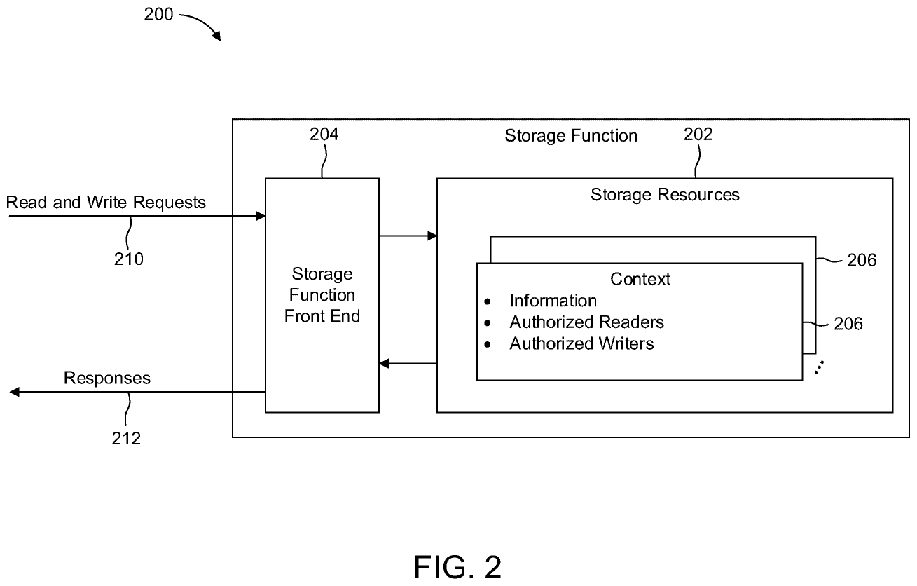

FIG. 2 is a system diagram illustrating an example storage function 200 architecture. The storage function 200 includes storage resources 202 and a Storage Function Front End 204. The storage function 200 stores instances of context 206 in the storage resources 202. The Storage Function Front End 204 authorizes access to each instance of context 206, and receives read and/or write requests 210, and sends responses 212 to the read and/or write requests 210. Each context instance 206 may include, for example, a list of network functions that are authorized to write (i.e., change, add, or delete) the context information and a list of network functions that are authorized to read (i.e., change, add, or delete) the context information.

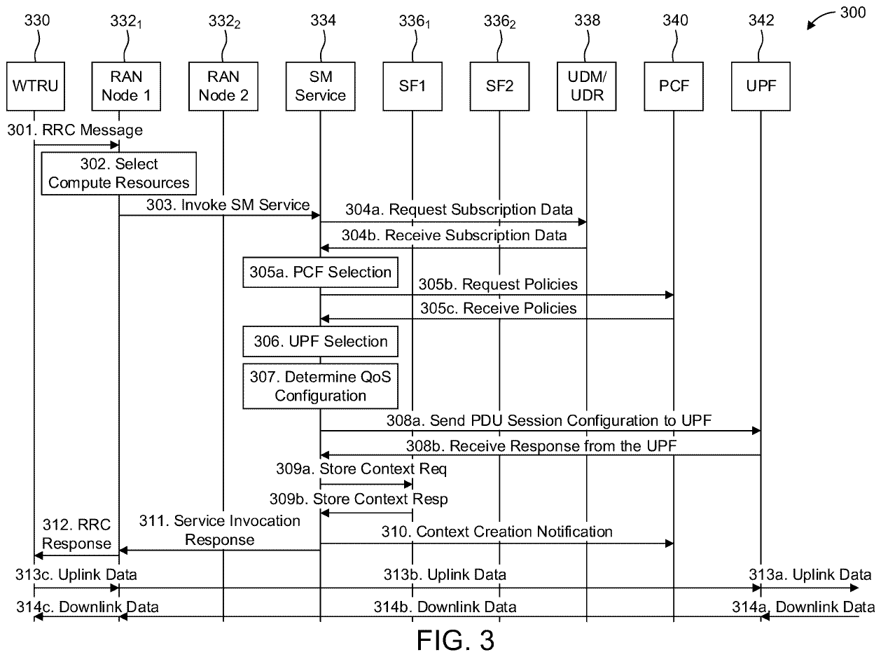

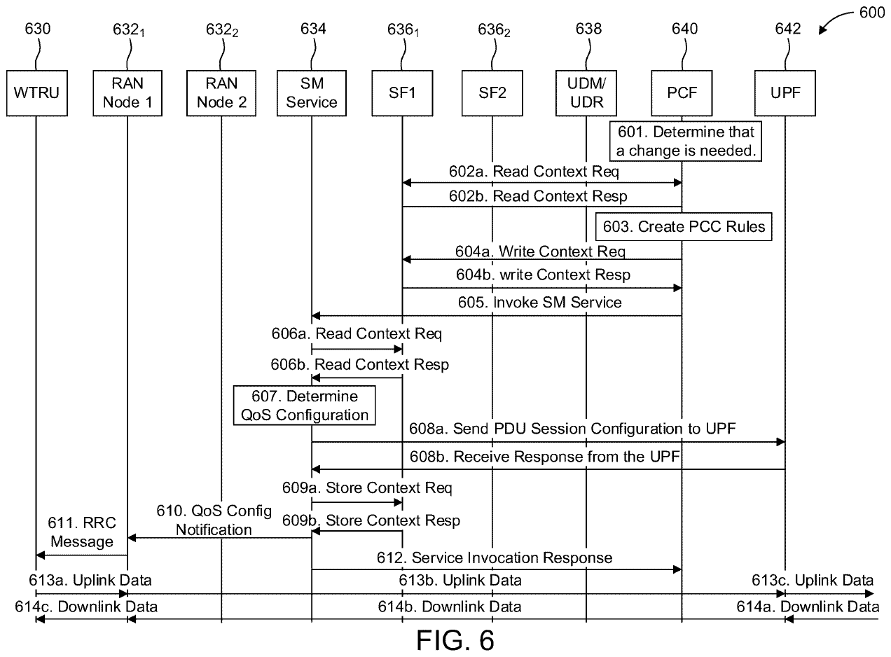

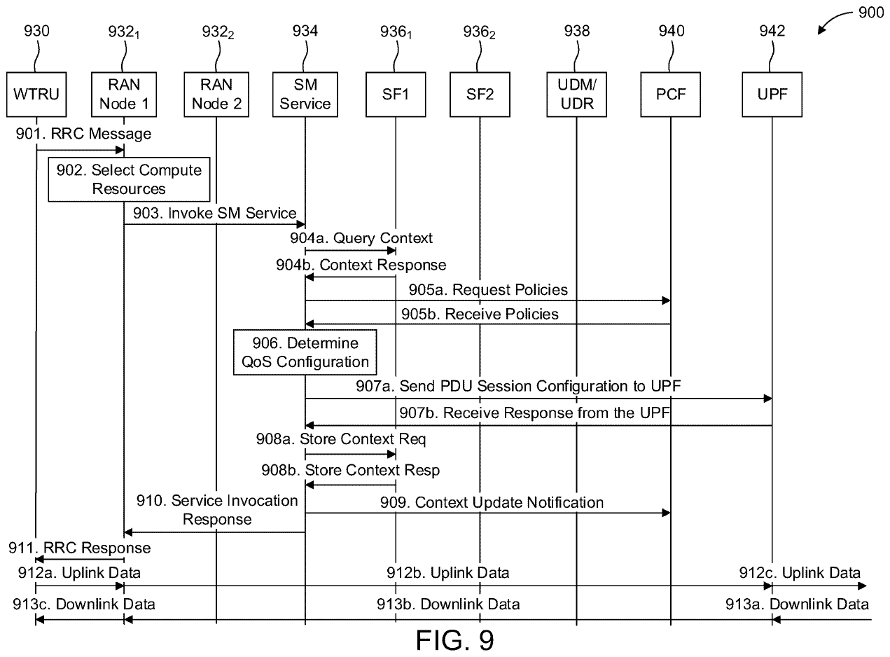

Each instance of context information may include an information element that indicates the type of context that is stored. In the example procedures of FIG. 3, FIG. 6, and FIG. 9, the type of context information that is stored is assumed to be session management context for illustrative purposes, although other types of context information may be stored similarly. The context information also includes an indication of whether only services from certain networks may read and/or write to the context instance. For example, the context information may indicate that only services that are run in the HPLMN of the WTRU may read and/or write to the context instance. In another example, the context information may indicate that only services that are run in the VPLMN of the WTRU may read and/or write to the context instance.

The context information may distinguish between which network functions (e.g., PCF) are allowed to read and/or write the context information and what type of services (i.e., a session management service) are allowed to read and/or write the context information. Furthermore, with respect to which types of services are allowed to read and/or write the context information, the context information may indicate whether the compute resources of the WTRU's home or visited network(s) are allowed to read and/or write the context information.

When the Storage Function receives a request to read or write the context information (e.g., as shown in messages 904a, 904b, 908a, and 908b of FIG. 9), the Storage Function will use the information form the context instance to determine whether the requestor (e.g., PCF or Service) is permitted to read and/or write the context instance. When the Storage Function receives a request to create a context instance (e.g., as shown in messages 309a and 309b of FIG. 3) the Storage Function will create a context identifier.

FIG. 3 is a signaling diagram illustrating an example session creation procedure 300 for WTRU context creation in a network. The example procedure 300 demonstrates how context (i.e., session management context, in this example) may be created for a WTRU's PDU Session. The network includes: WTRU 330, RAN Node 1 332₁, RAN Node 332₂, SM Service 334, Storage Function SF1 336₁, Storage Function SF2 336₂, UDM/UDR 338, PCF 340, and UPF 342. SM Service 334, Storage Function SF1 336₁, Storage Function SF2 336₂, UDM/UDR 338, PCF 340, and UPF 342 may be part of the core network (CN), and may reside on one or more entities or devices in the core network. For example, the SM Service 334 may be a service that runs on a server. The Storage Function SF1 336₁, Storage Function SF2 336₂, and UDM/UDR 338 may be functionalities that run in a server. The Storage Function SF1 336₁ and Storage Function SF2 336₂ may be associated with memory resources that are used to store context. The UDM/UDR 338 may be associated with memory resources that are used store WTRU subscription information. The UPF 342 may be functionality that runs on a data routed device. The PCF 340 may be functionality that runs on a server. The PCF 340 may be associated with memory resources that are used session policy information.

According to example session creation procedure 300, the WTRU 330 is triggered to send, to the network (e.g., RAN Node 1 332₁), an RRC message 301, where the RRC message 301 may be a PDU Session Establishment Request message. For example, the WTRU 330 may be triggered to send a PDU Session Establishment Request message 301 to the network when the WTRU 330 detects that a WTRU Application needs to send uplink data to a data network and the WTRU 330 has no PDU Session established with the data network.

The request message that is sent may be an RRC message 301 that carries a NAS payload. The NAS payload may contain two parts: a Service Invoker Payload (first payload) and a Service Payload (second payload). The first part of the NAS payload may be a Service Invoker Payload. The Service Invoker Payload is a part of the message that is read by the Service Invoker. In this example, the Service Invoker is RAN Node 1 332₁. The Service Invoker Payload may include an indication of the type of service that needs to be invoked by the Service Invoker (RAN Node 1 332₁). In this example, the type of service may be a Session Management Service. The indication of the type of service may be part of the Service Invoker Payload or in another part of RRC message 301.

The Service Invoker Payload may include compute resource selection assistance information. Compute resource assistance information may be multiple information elements. The compute resource assistance information may be used by the Service Invoker (RAN Node 1 332₁) to select compute resources to execute the type of service that is indicated in the Service Invoker Payload. For example, the compute resource selection assistance information may include a DNN. The DNN identifies the data network to which the WTRU 330 needs to establish the PDU Session. The Service Invoker (RAN Node 1 332₁) may be configured with a policy that is used to determine whether compute resources of the VPLMN or HPLMN should be used to execute the service. For example, the data network may be a data network that is deployed by the VPLMN and therefore the Session Management Service will need to select a UPF that is deployed by the VPLMN. Thus, the compute resources that execute the Session Management Service may need to compute resources of the VPLMN. For example, the data network may be a data network that is deployed by the HPLMN and therefore the Session Management Service will need to select a UPF that is deployed by the HPLMN. Thus, the compute resources that execute the Session Management Service may need to be compute resources of the HPLMN. A PDU Session that is deployed by the VPLMN may be called a local breakout PDU Session. A PDU Session that is deployed by the HPLMN may be called a home routed PDU Session.

The second part of the NAS payload may be a Service Payload. The Service Payload is a part of the message that is provided by the Service Invoker (RAN Node 1 332₁) to the Service. In this example, the Service is the Session Management Service 334. After using Service Invoker Payload to select compute resources (at 302), the Service Invoker (RAN Node 1 332₁) may provide the Service Payload to the selected compute resources and provide an indication that the Service Payload should be used to execute a session management service operation. In this example, the service payload will indicate that the session management service operation is a session establishment operation.

In a PDU Session Establishment example, the Service Payload may include an DNN, an S-NSSAI, an SSC Mode, and a PDU Session Type. In another example, if an information element is such as DNN is included in the Service Invoker Payload, the DNN might not be included in the in the Service Payload and the RAN Node 1 332₁ may provide the DNN to the SM Service 334 when the RAN Node 1 332₁ provides the service payload to the service. In an example, the Service Invoker Payload and Service Payload may be secured differently. For example, the Service Invoker Payload may be secured based on a security context between the WTRU 330 and RAN Node 1 332₁. For example, the Service Payload may be secured based on a security context between the WTRU 330 and the Core Network.

At step 302, RAN Node 1 332₁ may read the Service Invoker Payload to determine what type of service needs to be invoked and RAN Node 1 332₁ may use compute resource assistance information to select compute resources to invoke the service. In this example, the service is a session management service 334. In another example not shown, RAN Node 1 332₁ may send the Service Invoker Payload to a proxy so that the proxy can select the compute resources and invoke the service. RAN Node 1 332₁ may determine what proxy to send the Service Invoker Payload to based on the identity of the WTRU's 330 home network or based on the compute resource assistance information. For example, the compute resource assistance information may indicate what PLMN should anchor the PDU Session. For example, the compute resource assistance information may indicate if the PDU Session should be home routed or if the PDU Session should be a local break session that is anchored in the visited network. For example, the compute resource assistance information may include information (e.g., a DNN) that is used to determine if the PDU Session should be home routed or if the PDU Session should be a local break session that is anchored in the visited network. When the RAN Node 1 332₁ provides the Service Payload to the proxy, the RAN Node 1 332₁ may also indicate what type of service needs to be invoked. Notice that the proxy would not need to inspect or decrypt or understand the contents of the service payload, the proxy would only need to select a service (i.e., compute resources) and send the service payload to the service. The proxy may be a load balancer.

The service invoker, which is RAN Node 1 332₁ in this example, may send an invoke SM service request message 303 to trigger the compute resources that were selected at step 302 to invoke the session management service 334. The request message 303 may include the Service Payload and/or a WTRU Identifier of the WTRU 330. A SUPI is an example of a WTRU Identifier. In an example, the RAN Node 1 332₁ may provide the WTRU identifier to the SM service 334 because the RAN Node 1 332₁ already has an authenticated connection with the WTRU 330.

The session management service 334 may use the information from the Service Payload to obtain WTRU subscription information of the WTRU 330. The WTRU subscription information may be obtained from a subscription database such as the UDM/UDR 338 (may be referred to as UDR 338). For example, the SM Service 334 may send a request message 304a to the UDR 338 (UDM/UDR 338) to obtain WTRU Subscription Information. The SM Service 334 may determine which UDR to request the WTRU Subscription Information from based on the WTRU Identifier that was provided to the SM Service 334 by the Service Invoker (RAN Node 1 332₁). The SM Service 334 may receive the WTRU Subscription Information from the UDR 338 (UDM/UDR 338). The SM Service 334 may use the information from the WTRU Subscription Information to determine that the creation of the PDU Session should be authorized. Based on the PDU Session being authorized, the SM Service 334 may assign a PDU Session Identifier to the PDU Session.

The WTRU subscription information may be used by the session management service to select a PCF 340 and obtain policies from the PCF 340. At step 305a, the SM Service 334 may select a PCF 340. The SM Service 334 may determine which PCF 340 to request the policies from based on the WTRU Identifier that was provided to the SM Service 334 by the Service Invoker (RAN Node 1 332₁), based on the DNN that was included in the Service Payload, or based on a combination of both the DNN and WTRU Identifier. The SM Service 334 may send a request message 305b to request policies to the selected PCF 340 to obtain policies from the PCF 340. The request message 305b may include the PDU Session Identifier, the DNN, and/or the WTRU Identifier. The request message 305b may serve as a notification to the PCF 340 that the PCF 340 is the serving PCF of the PDU Session that is associated with the PDU Session Identifier. The SM Service 334 may receive a message 305c included the received policies from the PCF 340. The received policies may be policies that specifically describe what type of QoS treatment should be given to the WTRU's 330 traffic when the WTRU 330 sends and receives data to the DN. The policies may be policies that generally describe what type of QoS treatment should be given to any WTRU's 330 traffic when the WTRU 330 sends and receives data to the DN. The PCF 340 may have obtained WTRU subscription information and used the WTRU subscription information to construct the policies. The policies may be PCC Rules.

At step 306, the SM Service 334 may select a UPF 342. Selection of the UPF may be based on information that is in the service payload (e.g., a DNN and S-NSSAI combination). At step 307, the SM Service 334 may determine a QoS Configuration for the PDU Session. The QoS Configuration may include rules that will be applied by the UPF 342 (e.g., N4 Rules), rules that will be applied by the RAN Node 1 332₁ (e.g., QoS Profiles), and/or rules that will be applied by the WTRU 330 (e.g., QoS Rules). The SM Service 334 may configure the UPF 342 to serve as the anchor for the PDU Session, by sending a message 308a including PDU session configuration to the UPF 342, and receiving a response message 308b from the UPF 342. Configuring the UPF 342 to serve as the anchor for the PDU Session includes providing, in message 308a, rules to the UPF 342 so that the UPF 342 may determine what QoS treatment is required for traffic of the PDU Session and configuring the UPF 342 with information about what RAN Node (RAN Node 1 332₁) should be used to send data to and from the WTRU 330. Tunnel information is an example of information about a RAN Node. In this example, the information would be about RAN Node 1 332₁.

The SM Service 334 may create and store context information for the PDU Session in a storage function (e.g., storage function SF1 336₁), by sending store context request message 309a to Storage Function SF1 336₁, and receiving Store Context response message 309b from Storage Function SF1 336₁. The context information may include, but is not limited to include, any of the following information: the WTRU Identity; the PDU Session Identifier; the identity of the PCF that serves the PDU Session (i.e., the PCF that was selected in step 305); The QoS Configuration; the identity of the PSA UPF (that was selected in step 306); and/or the identity of the RAN Node that serves the PDU Sessions (RAN Node 1 332 A context identifier may be assigned to the context. The context identifier may be assigned by the storage function SF1 336₁ and be provided to the SM service 334 in Store Context Response message 309b.

The SM service 334 may send a notification message 310 to the PCF 340. The notification message 310 may be a context creation notification and may indicate to the PCF that a context instance was created in Storage Function SF1 336₁ for the PDU Session. The notification message 310 may include the PDU Session ID and/or the context identifier. In an example not shown, the storage function SF1 336₁ may send the notification message 310 to the PCF 340. For example, the storage function front end may be triggered to send the notification message 310 to the PCF 340 when the context instance is created based on the context instance including the PCF ID and indicating that the PCF 340 serves the PDU Session. The SM Service 334 may send a response message 311 to the Service Invoker (i.e., RAN Node 1 332₁). The response message 311 may be service invocation response message and may include any of an indication that the service invocation was successful, a QoS Configuration (i.e., QoS Profile) for the RAN Node (RAN Node 1 332₁), the context identifier, and/or a payload response for the WTRU 330. The payload response for the WTRU 330 may include QoS Configuration for the WTRU 330 (i.e., QoS Rules) for the PDU Session. The payload response for the WTRU 330 may include the context identifier and PDU Session ID. The payload response for the WTRU 330 may be secured (i.e., encrypted) based on a security context that was established between the WTRU 330 and core network. In other words, the RAN Node 1 332₁ may not be able to read or understand the payload response portion of response message 311.

The RAN Node 1 332₁ may send an RRC Response message 312 to the WTRU 330. The RRC Response message 312 may include the payload that was received from the SM Service 334 for the WTRU 330. Uplink data 313c is received by the RAN Node 1 332₁ from the WTRU 330. The RAN Node 1 332₁ may use the tunnel between the UPF 342 and the RAN node 1 332₁ to forward the uplink data 313b to the UPF 342. The UPF 342 forwards the uplink data 313a to the data network (not shown). Downlink data 314a is received by the UPF 342 via the data network (not shown). The UPF 342 uses the tunnel between the UPF 342 and RAN node 1 332₁ to forward the downlink data 314b to the RAN Node 1 332₁. The RAN Node 1 332₁ forwards the downlink data 314c to the WTRU 330.

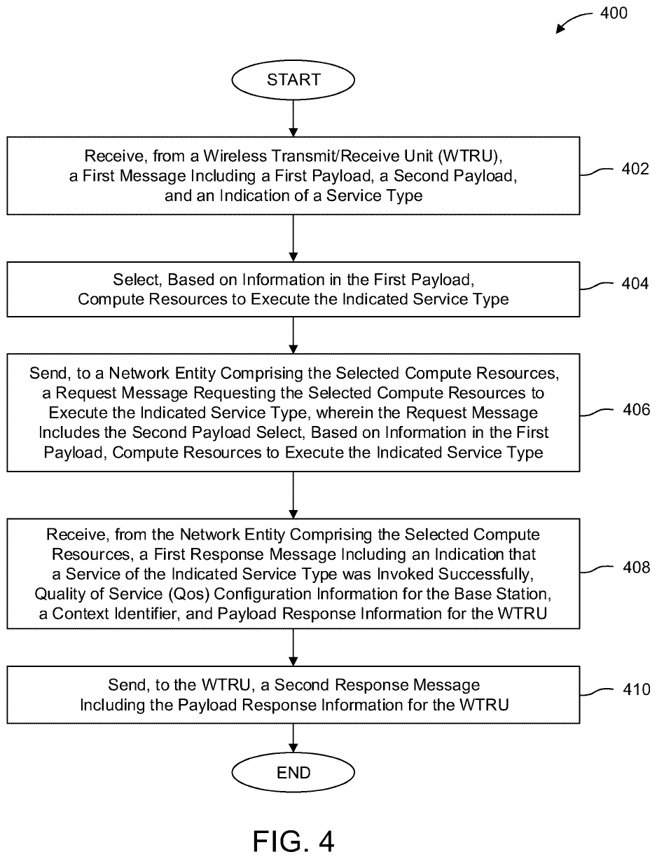

FIG. 4 is a flow diagram illustrating an example session creation procedure 400 for WTRU context creation in a network, which may be performed by a base station (RAN Node). At 402, the base station may receive, from a wireless transmit/receive unit (WTRU), a first message including a first payload, a second payload, and an indication of a service type. At 404, the base station may select, based on information in the first payload, compute resources to execute the indicated service type. At 406, the base station may send, to a network entity comprising the selected compute resources, a request message requesting the selected compute resources to execute the indicated service type, wherein the request message includes the second payload. At 408, the base station may receive, from the network entity comprising the selected compute resources, a first response message including an indication that a service of the indicated service type was invoked successfully, quality of service (QoS) configuration information for the base station, a context identifier, and payload response information for the WTRU. At 410, the base station may send, to the WTRU, a second response message including the payload response information for the WTRU.

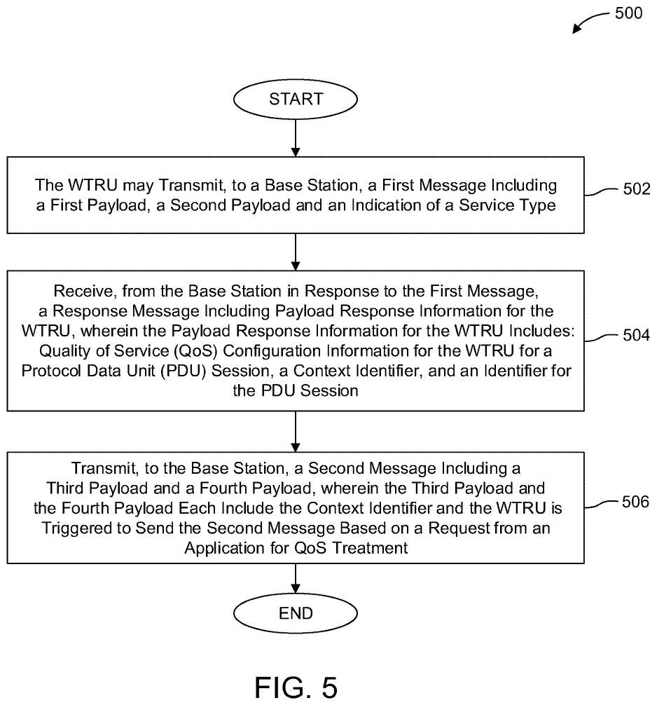

FIG. 5 is a flow diagram illustrating an example session creation procedure 500 for WTRU context creation in a network, which may be performed by a WTRU. At 502, the WTRU may transmit, to a base station, a first message including a first payload, a second payload and an indication of a service type. At 504, the WTRU may receive, from the base station in response to the first message, a response message including payload response information for the WTRU, wherein the payload response information for the WTRU includes: quality of service (QoS) configuration information for the WTRU for a protocol data unit (PDU) session, a context identifier, and an identifier for the PDU session. At 506, the WTRU may transmit, to the base station, a second message including a third payload and a fourth payload, wherein the third payload and the fourth payload each include the context identifier and the WTRU is triggered to send the second message based on a request from an Application for QoS treatment.

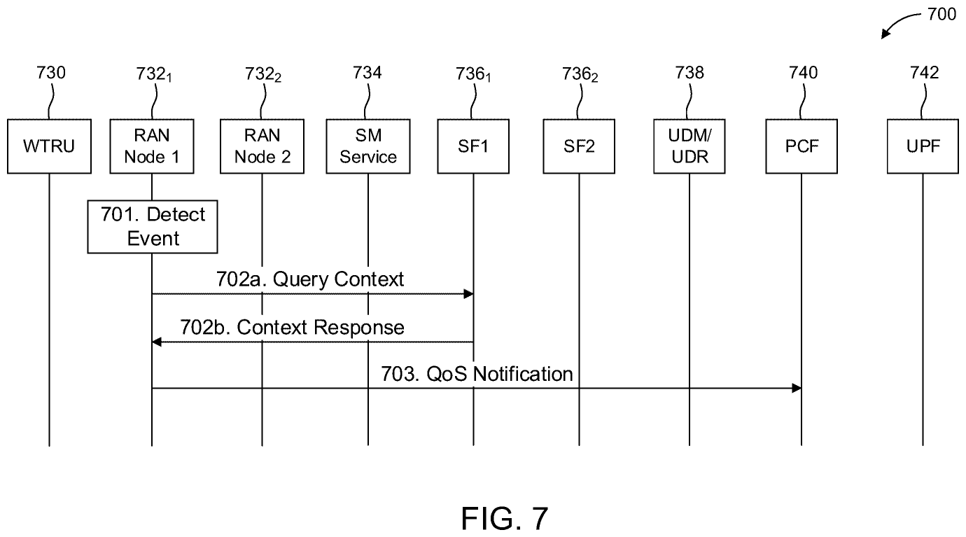

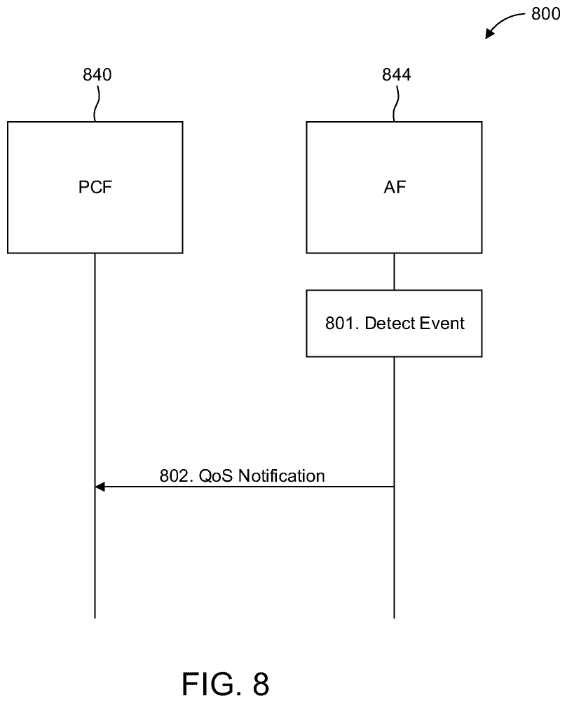

Procedures for PCF initiated change are described in the following. An outcome of the session creation procedure 300 of FIG. 3 is the establishment of a PDU Session for the WTRU. Once a PDU Session is established (i.e., after the session creation procedure 300 of FIG. 3 is executed), the PCF may determine that it needs to change the PCC Rules of the session. The PCF may make this decision based on a notification from the RAN Node that indicates that the current QoS Settings of the PDU Session cannot be satisfied by the network (an example of the PCF receiving a notification from the RAN Node is shown in FIG. 7, described below). The PCF may make this decision based on a request from an AF that indicates that the current QoS Settings of the PDU Session should be changed (an example of the PCF receiving a request from an AF is shown in FIG. 8, described below). FIG. 6 shows an example procedure of how the PCF can change the QoS Settings of the PDU Session.

FIG. 6 is a signaling diagram illustrating an example PCF-initiated change procedure 600 in a network. The network includes: WTRU 630, RAN Node 1 632₁, RAN Node 632₂, SM Service 634, Storage Function SF1 636₁, Storage Function SF2 636₂, UDM/MDR 638, PCF 640, and UPF 642. SM Service 634, Storage Function SF1 636₁, Storage Function SF2 636₂, UDM/MDR 638, PCF 640, and UPF 642 may be part of the core network (CN), and may reside on one or more entities or devices in the core network. For example, the SM Service 634 may be a service that runs on a server. The Storage Function SF1 636₁, Storage Function SF2 636₂, and UDM/MDR 638 may be functionalities that run in a server. The Storage Function SF1 636₁ and Storage Function SF2 636₂ may be associated with memory resources that are used to store context. The UDM/MDR 638 may be associated with memory resources that are used store WTRU subscription information. The UPF 642 may be functionality that runs on a data routed device. The PCF 640 may be functionality that runs on a server. The PCF 640 may be associated with memory resources that are used session policy information.

At step 601, the PCF 640 may determine that the configuration of the PDU Session may need to be changed. This determination may be triggered by a notification (not shown) from the RAN Node 1 632₁ (e.g., as shown in FIG. 7). This notification may be triggered by a request from an AF (e.g., as shown in FIG. 8). The notification from the RAN Node 1 632 may include the PDU Session ID and the PCF 640 may use the PDU Session ID to determine the Context Identifier. The request from the AF may include a flow descriptor or a WTRU identifier and a DNN. The PCF 640 may use the flow descriptor or a WTRU identifier and DNN to determine the PDU Session ID and Context Identifier. The PCF 640 may trigger this procedure after detecting a change in the location of the WTRU 630. For example, the PCF 640 may receive WTRU 630 location information from a location management function, or an application function and the PCF 640 may, based on the WTRU's 630 location, determine to invoke the SM Service 634. The SM Service 634 can then determine if the WTRU's 630 context needs to be relocated (i.e., stored in a different SF) and determine if the UPF 642 that anchors the PDU Session should change. For example, the PCF 640 may receive an overload indication from the Operations, Administration and Maintenance (OAM) System that indicates that certain compute resources, storage resources, or UPF(s) 642 are experiencing overload. The PCF 640 may, based on the overload indication, determine to the invoke the SM Service 634. The SM Service 634 can then determine if the WTRU's 630 context needs to be relocated (i.e., stored in a different SF) and determine if the UPF 642 that anchors the PDU Session should change.

The PCF 640 may read the context of the PDU Session from the storage function SF1 6361, by sending a read context request message 602a to storage function SF1 636₁ and receiving, from storage function SF1 636₁, a read context response message 602b. The request message 602a that is sent from the PCF 640 to the Storage Function SF1 636₁ may include the context identifier. The context information that is received from the storage function SF1 636₁ in response message 602b may include the PCC Rules that were last generated by the PCF 640 and application layer session requirements. At step 603, the PCF 640 may use the application layer session requirements and the information from the RAN Node 1 632₁ Notification or AF to generate a new set of PCC Rules. For example, the RAN Node notification may have indicated QoS Requirements that can be achieved, and the PCF 640 may generate new PCC Rules based on the QoS Requirements that can be achieved.

The PCF 640 may update the context instance for the PDU Session by replacing the current PCC Rules with the PCC Rules that were generate at step 603, by sending Write Context Request message 604a to the Storage Function SF1 636₁ and receiving, from Storage Function SF1 636₁, Write Context Response message 604b. The PCF 640 may invoke the SM Service 634 by sending invoke SM service message 605 to the SM Service 634. When the PCF 640 invokes the SM Service 634, the PCF 640 may provide the context identifier and an indication that the service is being invoked because the PCC Rules have changed. Note that the PCF 640 may select the SM Service 632 before invoking the SM Service 634. The compute resources/SM Service 634 that is selected by the PCF 640 may be different than the SM Service that was run when the context for the PDU Session was established.

In step 6, the SM Service will read the context for the PDU Session from the storage function.

Alternatively, the PCF may send the context information from the PCF. If the context information is received from the PCF, the SM Service would not need to read the context information from the storage function. However, an approach where the SM Service obtains the context information from the storage function enables the storage function to ensure that the context information is only read by authorized consumers. At step 607, the SM Service 634 may determine a new QoS Configuration based on the new PCC Rules which are part of the context information. The SM Service 634 may configure the UPF 642 by sending PDU Session Configuration message 608a to the UPF 642 and receiving, from the UPF 642, Response message 608b (e.g., similar to messages 308a and 308b of FIG. 3).

The SM Service 634 may store the PDU Session context by sending Store Context Request message 609a to the Storage Function SF1 636₁ and receiving, from the Storage Function SF1 636₁, Store Context Response message 609b (e.g., similar to messages 309a and 309b of FIG. 3). The SM Service 634 may configure the RAN Node 1 632₁ and send updated configuration information in QoS Configuration Notification message 610 to the RAN Node 1 632₁. The RAN Node 1 632₁ may send the updated configuration in RRC message 611 to the WTRU (similar to message 312 of FIG. 3). The SM Service 632 may send, in Service Invocation Response message 612, an indication to the PCF 640 to indicate that the PDU Session has been reconfigured. Uplink data 613a is received by the RAN Node 1 632₁ from the WTRU 630. The RAN Node 1 632₁ may use the tunnel between the UPF 642 and the RAN node 1 632₁ to forward the uplink data 613b to the UPF 642. The UPF 642 forwards the uplink data 613c to the data network (not shown). Downlink data 614a is received by the UPF 642 via the data network (not shown). The UPF 642 uses the tunnel between the UPF 642 and RAN node 1 632₁ to forward the downlink data 614b to the RAN Node 1 632₁. The RAN Node 1 632₁ forwards the downlink data 614c to the WTRU 630.

Procedures for triggering a PCF by a RAN notification are described herein. FIG. 7 shows an example procedure of how a RAN Node can trigger the PCF to create new PCC Rules for a PDU Session. FIG. 7 is a signaling diagram illustrating an example procedure 700 for PCF-initiated change based on a RAN Notification in a network. The network includes: WTRU 730, RAN Node 1 732₁, RAN Node 732₂, SM Service 734, Storage Function SF1 736₁, Storage Function SF2 736₂, UDM/MDR 738, PCF 740, and UPF 742. SM Service 734, Storage Function SF1 736₁, Storage Function SF2 736₂, UDM/MDR 738, PCF 740, and UPF 742 may be part of the core network (CN), and may reside on one or more entities or devices in the core network. For example, the SM Service 734 may be a service that runs on a server. The Storage Function SF1 736₁, Storage Function SF2 736₂, and UDM/MDR 738 may be functionalities that run in a server. The Storage Function SF1 736₁ and Storage Function SF2 736₂ may be associated with memory resources that are used to store context. The UDM/MDR 738 may be associated with memory resources that are used store WTRU subscription information. The UPF 742 may be functionality that runs on a data routed device. The PCF 740 may be functionality that runs on a server. The PCF 740 may be associated with memory resources that are used session policy information. Creation of the new PCC Rules may result in modification of the QoS Configuration of the PDU Session (as shown in example procedure 600 of FIG. 6). The QoS Configuration of the PDU Session refers to how the WTRU 730, RAN Node 1 732₁, and the UPF 742 are configured to treat, or prioritize the data of the PDU Session.

At Step 701, the RAN Node 1 732₁ may determine to notify the PCF 740 of an event. The reason for notifying the PCF 740 of the event is that information that is related to the event may be used to create new PCC Rules for the PDU Session. Examples of events that the RAN Node 1 732₁ might notify the PCF 740 about include: detection of congestion in the network, and determining that the maximum data rate that is available for the PDU Session or a QoS Flow of a PDU Session has changed. The RAN Node 1 732₁ may read the PDU Session context from the storage function SF1 736₁, by sending to the storage function SF1 736₁ Query Context message 702a and receiving, from the storage function SF1 736₁, Context Response message 702b. The PDU Session context may include the identity of the PCF 740 that serves the PDU Session. The RAN Node 1 732₁ may send the PDU Session ID to the storage function SF1 736₁ to identify which PDU Session context needs to be read. The PDU Session ID may be sent to the storage function SF1 736₁ in the Query Context message 702a. The RAN Node 1 732₁ may send the QoS notification message 703 to the PCF 740. The QoS notification message 703 may include information about the event that was detected at step 701. Reception of the QoS notification message 703 by the PCF 740 may trigger a PCF-initiated change procedure, such as the PCF-initiated change procedure 600 of FIG. 6.

Example procedures for the PCF to be triggered by an AF request for a QoS change are described herein. FIG. 8 shows an example procedure of how an AF can trigger the PCF to create new PCC Rules for a PDU Session. Creation of the new PCC Rules may result in modification of the QoS Configuration of the PDU Session (e.g., example procedure 600 of FIG. 6). The QoS Configuration of the PDU Session may refer to how the WTRU, RAN Node and UPF are configured to treat, or prioritize the data of the PDU Session. QoS Configuration may include, but is not limited to include: PCC Rules, QoS Rules, QoS Profile, and N4 Rules.

FIG. 8 is a signaling diagram illustrating an example procedure 800 for PCF-initiated change based on an AF notification in a network. The PCF 840 and AF 844 are shown, and other functions and entities in the network are not shown. At step 801, the AF 844 may determine to notify the PCF 840 of an event (detect an event). The reason for notifying the PCF 840 of the event is that information that is related to the event may be used to create new PCC Rules for the PDU Session. For example, the AF 844 may notify the PCF 840 when the QoS requirements for a flow change. The QoS requirements for a flow may change when application layer settings change. An example of an application layer setting is a video codec configuration. The AF 844 may send a QoS notification message 802 to the PCF 840. The notification message 802 may include information about the event that was detected in step 801. Reception of the notification message 802 by the PCF 840 may trigger a PCF-initiated change procedure (e.g., PCF-initiated change procedure 600 of FIG. 6).

Example procedures for UE initiated change are described herein. Once a PDU Session is established (e.g.,, after the procedure 300 of FIG. 3 is executed), the WTRU may determine that it wants to change the characteristics of the PDU Session. For example, the WTRU may determine that it wants to request QoS treatment for a flow of data this sent and/or received in the PDU Session. The WTRU may make this decision based on a request from an application that is hosted in the WTRU and/or by detecting that a type of application is sending traffic in the PDU Session.

FIG. 9 is a signaling diagram illustrating an example procedure 900 for WTRU-initiated change in a network. The example procedure 900 shows how the WTRU 930 can change the QoS Settings of the PDU Session. The network includes: WTRU 930, RAN Node 1 932₁, RAN Node 932₂, SM Service 934, Storage Function SF1 936₁, Storage Function SF2 936₂, UDM/MDR 938, PCF 940, and UPF 942. SM Service 934, Storage Function SF1 936₁, Storage Function SF2 936₂, UDM/MDR 938, PCF 940, and UPF 942 may be part of the core network (CN), and may reside on one or more entities or devices in the core network. For example, the SM Service 934 may be a service that runs on a server. The Storage Function SF1 936₁, Storage Function SF2 936₂, and UDM/MDR 938 may be functionalities that run in a server. The Storage Function SF1 936₁ and Storage Function SF2 936₂ may be associated with memory resources that are used to store context. The UDM/MDR 938 may be associated with memory resources that are used store WTRU subscription information. The UPF 942 may be functionality that runs on a data routed device. The PCF 940 may be functionality that runs on a server. The PCF 940 may be associated with memory resources that are used session policy information.

According to example session creation procedure 900, the WTRU 930 is triggered to send, to the network (e.g., RAN Node 1 932₁), an RRC message 901, wherein RRC message 901 may be a PDU Session Modification Request to the network. For example, the WTRU 930 may be triggered to send a PDU Session Modification Request message 901 to the network when the WTRU 930 receives a request for QoS Treatment for a flow from an application. For example, the WTRU may be triggered to send a PDU Session Modification Request to the network when the WTRU 930 detects that a certain type of application is sending data in the PDU Session.

The request message that is sent may be an RRC message 301 that carries a NAS payload. The NAS payload may contain two parts: a Service Invoker Payload (first payload) and a Service Payload (second payload). The first part of the NAS payload may be the Service Invoker Payload. The Service Invoker Payload includes the context identifier and/or PDU Session ID. The Service Invoker Payload includes at least an indication of the type of service that needs to be invoked by the service invoker. In this example, the type of service may be a Session Management Service 934. Inclusion of the context identifier and/or PDU Session ID in the Service Invoker Payload may indicate that the request is to modify an existing session. The Service Invoker Payload may include compute resource selection assistance information. The compute resource assistance information may be multiple information elements and may be the same compute resource assistance information that was described in RRC message 301 of the procedure 300 of FIG. 3.

With reference to FIG. 9, the context identifier and/or PDU Session ID may also be considered compute resource selection assistance information because the context identifier and/or PDU Session ID may be formatted such that they indicate where the context of the session is stored. For example, the format of the context identifier and/or PDU Session ID may indicate the network (i.e., VPLMN or HPLMN) where the context is stored. The network where the context is stored may influence the RAN Node's 932₁ selection of compute resources to run the Session Management Service 934. For example, the RAN Node 1 932₁ may prefer to invoke the Session Management Service 934 on compute resources that are operated by the same network that stores the context.

The second part of the NAS payload may be a Service Payload. The Service Payload is a part of the message that is provided by the Service Invoker (RAN Node 1 932₁) to the Service. In this example, the Service is the Session Management Service 934. After using Service Invoker Payload to select compute resources, the Service Invoker may provide the Service Payload to the selected compute resources and provide an indication that the Service Payload should be used to execute a session management service operation. In this example, the service invoker will indicate that the session management service operation is a session modification operation.

The Service Payload may indicate that the purpose of the request is PDU Session Modification. In this PDU Session Modification Example, the Service Payload may include the PDU Session ID and/or Context ID. The Service Payload may also include a flow description and a description of the QoS treatment that is required for the flow. The flow description may include a source IP Address, a source port number, a destination IP Address, and a destination port number. The description of the QoS treatment may include a 5QI, a packet delay budget value, and a maximum error rate value. Similar to the procedure 300 of FIG. 3, the Service Invoker Payload and Service Payload may be secured differently. For example, the Service Invoker Payload may be secured based on a security context between the WTRU 930 and RAN Node1 932₁. For example, the Service Payload may be secured based on a security context between the WTRU 930and Core Network.

At step 902, RAN Node 1 932₁ may read the Service Invoker Payload to determine what type of service needs to be invoked and RAN Node 1 932₁ may use compute resource assistance information to select compute resources to invoke the service. In this example, the service is a session management service 934. In an example not shown, RAN Node 1 932₁ may send the Service Invoker Payload to a proxy (as described in step 302 of the procedure 300 of FIG. 3). The service invoker, which is RAN Node 1 932₁ in this example, may send a request message, for example an invoke SM Service message 903, to trigger the compute resources that were selected in the RRC message 901 to invoke the session management service 934. The request message 903 may include the Service Payload and/or a WTRU Identifier. A SUPI is an example of a WTRU Identifier. The RAN Node 1 932₁ may provide the WTRU identifier to the service 934 because the RAN Node 1 932₁ already has an authenticated connection with the WTRU 930.

The SM Service 934 may read the PDU Session Context from the Storage Function SF1 936₁. The SM Service 934 may send a query context request message 904a to the Storage Function SF1 936₁. The query request message 904a may identify context that needs to be read. For example, the query request message 904a may include the context ID that was received in message 903. The SM Service 934 may receive the PDU Session Context in a context response message 904b from the storage function SF1 936₁. For example, the PDU Session Context may be the PDU Session Context that was stored in the storage function in step 309 of the procedure 300 of FIG. 3.

The SM Service 934 may send information from the Service Payload, in Request Policies message 905a, to the PCF 940 that serves the PDU Session. The SM Service 934 knows the identity of the PCF 940 that services the PDU Session because the identity of the PCF 940 was in the context information that the SM Service 934 received in message 904b. Requested QoS is an example of information from the Service Payload that the SM Service 934 may send to the PCF 940. For example, the SM Service 934 may send information to the PCF 940 that describes the QoS that the WTRU 930 requested for a flow. The PCF 940 may respond to the SM Service 934 and send new PCC Rules to the SM Service 934 in the response message 905b (Receive Policies response message 905b). The new PCC Rules may be based on QoS treatment that was requested by the WTRU 930.

At step 906, the SM Service 934 may determine a QoS Configuration for the PDU Session, for example as described in step 307 of the procedure 300 of FIG. 3. The SM Service 934 may configure the UPF 942 by exchanging with the UPF 942 a PDU Session Configuration message 907a and Response message 907b, similar to messages 308a and 308b of the procedure 300 of FIG. 3. The SM Service 934 may create and store an updated version of context information for the PDU Session in the storage function SF1 936₁, by exchanging with SF1 936₁ Store Context Request message 908a and Store Context Response message 908b. The context information may include, but is not limited to include: the WTRU Identity; the PDU Session Identifier; the identity of the PCF that serves the PDU Session (i.e., the PCF that was selected in step 5); the QoS Configuration; the identity of the PSA UPF 942 that was selected in step 906, and/or the identity of the RAN Node 1 932₁ that serves the PDU Sessions.

Similar to Notification message 310 of FIG. 3, a context update notification message 909 is sent by the SM service 934 to the PCF 940. The notification message 909 may indicate to the PCF 940 that a context was updated in Storage Function SF1 936₁ for the PDU Session. The notification message 909 may indicate the reason for the update or may indicate what context information was updated so that the PCF 940 can decide if it needs to read the updated information. For example, the SM Service 934 may indicate that QoS Rules were updated based on the new PCC Rules and the PCF 940 may determine that it does not need to read or write to the new context information. The SM Service 934 may send a Service Invocation response message 910 to the Service Invoker (i.e., RAN Node 1 932₁). The Service Invocation response message 910 may include: an indication that the service invocation was successful; a QoS Configuration (i.e., QoS Profile) for the RAN Node 1 932₁; the context identifier; and/or a payload response for the WTRU 930. The payload response may include QoS Configuration for the WTRU 930 (i.e., QoS Rules) for the PDU Session. The payload response may include the context identifier and PDU Session ID. Similar to Response message 311 of FIG. 3, the payload response may be secured (i.e., encrypted) based on a security context that was established between the WTRU and core network. In other words, the RAN Node may not be able to read or understand the payload response.

The RAN Node 1 932₁ may send an RRC Response message 911 to the WTRU 930. The RRC Response message 911 may include the payload that was received from the SM Service 934 for the WTRU 930.

Uplink data 912a is received by the RAN Node 1 932₁ from the WTRU 930. The RAN Node 1 932₁ may use the tunnel between the UPF 942 and the RAN node 1 932₁ to forward the uplink data 912b to the UPF 942. The UPF 942 forwards the uplink data 312c to the data network (not shown). Downlink data 913a is received by the UPF 942 via the data network (not shown). The UPF 942 uses the tunnel between the UPF 942 and RAN node 1 932₁ to forward the downlink data 913b to the RAN Node 1 932₁. The RAN Node 1 932₁ forwards the downlink data 913c to the WTRU 330.

Example procedures for handover events are disclosed herein. When a handover event occurs, the WTRU may trigger a PDU Session Modification procedure (e.g., PDU Session Modification procedure 900 of FIG. 9). The Service Invoker Payload may include an indication that the PDU Session Modification procedure was triggered by a handover event. The purpose of triggering a PDU Session Modification procedure when a handover event occurs is that the PDU Session Modification procedure may be used to inform the PCF of the identity of the RAN Node that is now serving the WTRU and the PDU Session Modification procedure may be used to move the endpoint of the tunnel between the old RAN Node and UPF so that the tunnel is now between the new RAN Node and UPF. Thus, a PDU Session Modification procedure, such as procedure 900 of FIG. 9, may be executed with a new RAN Node (i.e., RAN Node 2 932₂ in FIG. 9).

When the procedure 900 of FIG. 9 is triggered because of a handover event, the SM Service may retrieve the context information from Storage Function SF1 936₁, for example using messages 904a and 904b. However, the SM Service 934 may store the context in a different storage function, Storage Function SF2 936₂, for example using messages 908a and 908b with Storage Function SF2 936₂ instead of Storage Function SF2 936₁. An example reason for moving the content to a different storage function is that the second storage function (i.e., Storage Function SF2 936₂) may be geographically closer to the new RAN Node 2 932₂ and/or the WTRU's 930 location.

Example embodiment for delegated service invocation are disclosed herein. In the procedures 300 and 9000 of FIGS. 3 and 9, respectively, the RAN Node selects and invokes the SM Service. In the procedure 600 of FIG. 6, the PCF selects and invokes the SM Service. In an example, the RAN Node or PCF may send a request to an Invoker Proxy so that the Invoker Proxy can invoke the SM Service on behalf of the RAN Node or PCF. The request that is sent to the Invoker Proxy may include both the Service Payload and the Service Invoker Payload. The Invoker Proxy may use the content of the Service Invoker Payload to determine what instance of the SM Service to invoke. How the information in the Service Invoker Payload is used to select an SM Service instance is described herein. For example, the description of FIGS. 3, 6, and 9 describe how an SM Service instance can be selected based on information in the Service Invoker Payload. When the Service Invoker invokes the SM Service, the Service Invoker will provide the Service Payload to the selected SM Service instance.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A base station comprising:
a transceiver; and
a processor, wherein the transceiver and the processor are configured to:
receive, from a wireless transmit/receive unit (WTRU), a first message including a first payload, a second payload, and an indication of a service type;
select, based on information in the first payload, compute resources to execute the indicated service type;
send, to a network entity comprising the selected compute resources, a request message requesting the selected compute resources to execute the indicated service type, wherein the request message includes the second payload;
receive, from the network entity comprising the selected compute resources, a first response message including an indication that a service of the indicated service type was invoked successfully, quality of service (QoS) configuration information for the base station, a context identifier, and payload response information for the WTRU; and
send, to the WTRU, a second response message including the payload response information for the WTRU.

2. The base station of claim 1, wherein the payload response information for the WTRU includes at least one of:
QoS configuration information for the WTRU for a protocol data unit (PDU) session, the context identifier, or an identifier for the PDU session.

3. The base station of claim 2, wherein the second payload is secured based on a security context between the WTRU and a core network.

4. The base station of claim 1, wherein the first message is a radio resource control (RRC) message including a non-access stratum (NAS) payload, and the NAS payload comprises the first payload and the second payload.

5. The base station of claim 1, wherein the first payload includes an indication of a data network name (DNN).

6. The base station of claim 1, wherein the context identifier indicates a public land mobile network (PLMN) where a corresponding context is stored.

7. The base station of claim 1, wherein the compute resources are computation resources that run an instance of a stateless service, and the selection of the compute resources includes selection of a service instance.

8. A method performed by a base station comprising:
receiving, from a wireless transmit/receive unit (WTRU), a first message including a first payload, a second payload, and an indication of a service type;
selecting, based on information in the first payload, compute resources to execute the indicated service type;
sending, to a network entity comprising the selected compute resources, a request message requesting the selected compute resources to execute the indicated service type, wherein the request message includes the second payload;
receiving, from the network entity comprising the selected compute resources, a first response message including an indication that a service of the indicated service type was invoked successfully, quality of service (QoS) configuration information for the base station, a context identifier, and payload response information for the WTRU; and
sending, to the WTRU, a second response message including the payload response information for the WTRU.

9. The method of claim 8, wherein the payload response information for the WTRU includes at least one of: QoS configuration information for the WTRU for a protocol data unit (PDU) session, the context identifier, or an identifier for the PDU session.

10. The method of claim 9, wherein the second payload is secured based on a security context between the WTRU and a core network.

11. The method of claim 8, wherein the first message is a radio resource control (RRC) message including a non-access stratum (NAS) payload, and the NAS payload comprises the first payload and the second payload.

12. The method of claim 8, wherein the first payload includes an indication of a data network name (DNN).

13. The method of claim 8, wherein the context identifier indicates a public land mobile network (PLMN) where a corresponding context is stored.

14. The method of claim 8, wherein the compute resources are computation resources that run an instance of a stateless service, and the selecting the compute resources includes selecting a service instance.

15. A wireless transmit/receive unit (WTRU) comprising:
a transceiver; and
a processor, wherein the transceiver and the processor are configured to:
transmit, to a base station, a first message including a first payload, a second payload and an indication of a service type; and
receive, from the base station in response to the first message, a response message including payload response information for the WTRU, wherein the payload response information for the WTRU includes: quality of service (QoS) configuration information for the WTRU for a protocol data unit (PDU) session, a context identifier, and an identifier for the PDU session.

16. The WTRU of claim 15, wherein the transceiver and the processor are further configured to:
transmit, to the base station, a second message including a third payload and a fourth payload, wherein the third payload and the fourth payload each include the context identifier wherein the WTRU receives a trigger to send the second message based on a request from an application for QoS treatment.

17. The WTRU of claim 15, wherein the first payload is secured based on a security context between the WTRU and the base station and the second payload is secured based on a security context between the WTRU and a core network.

18. The WTRU of claim 15, wherein the first message is a radio resource control (RRC) message including a non-access stratum (NAS) payload, and the NAS payload comprises the first payload and the second payload.

19. The WTRU of claim 15, wherein the first payload includes an indication of a data network name (DNN).

20. The WTRU of claim 15, wherein the context identifier indicates a network where a corresponding context is stored.
